(19) United States
(12) Patent Application Publication
(10) Pub. No.: US 2026/0116440 A1
(43) Pub. Date: Apr. 30, 2026

(54) METHOD AND SYSTEM FOR IDENTIFYING TRACK RISKS BASED ON BIG DATA ANALYSIS

(71) Applicant: GA SKYTRAIN MOBILITY GROUP, LLC, Peachtree Corners, GA (US)

(72) Inventors: Dong CHEN, Chendu City (CN); Kui HUANG, Chendu City (CN); Huazhong LIU, Jiangyin City (CN); Jie HUAN, Jiangyin City (CN); Huaipeng GUO, Chendu City (CN)

(21) Appl. No.: 19/318,492

(22) Filed: Sep. 4, 2025

(30) Foreign Application Priority Data
Oct. 25, 2024 (CN) 202411496579.5

(51) Int. Cl. B61L 23/04; G01N 21/88; G06T 5/50; G06V 20/17

(52) U.S. Cl. CPC B61L 23/044; G01N 21/8851; G06T 5/50; G06V 20/17; G01N 2021/8854; G06T 2207/20221

(57) ABSTRACT

The invention discloses a method and system for identifying track risks based on big data analysis. The invention uses the YOLO model and SVM classifier to detect the track, extracts the multi-scale features of the track image, and can quickly and effectively detect the deformation and damage positions in the track. Based on the detection results, the RF model and BP neural network are used to further analyze the fault points of the track, and the output of each model is combined to accurately determine the fault points in the track, thereby reducing the misjudgment and omission of the fault points and providing effective support for subsequent inspection path planning. According to the fault points, the inspection path is formulated in combination with the greedy algorithm and the ant algorithm, which can effectively reduce inspection time, improve efficiency and safety of the train operation, and assist in train operation management.

### CROSS-REFERENCE TO RELATED PATENT APPLICATION

This application claims priority to and the benefit of Chinese Patent Application Serial No. 202411496579.5, filed Oct. 25, 2024, which is incorporated herein in its entirety by reference

### Field of the Invention

The present invention relates generally to the field of track safety, and more particularly to method and system for identifying track risks based on big data analysis.

### BACKGROUND OF THE INVENTION

During the operation of the track, it is necessary to check whether the track is deformed or damaged. With the development of science and technology, track detection technology is also constantly improving to improve the safety of train operation. At present, track detection methods mainly include manual detection and machine learning algorithm detection. Although the manual detection method is intuitive and reliable, it is inefficient and labor-intensive. Although the machine learning algorithm has improved the detection efficiency to a certain extent, it still has the problem of insufficient detection accuracy. Especially in complex environments, the accuracy and robustness of the algorithm still need to be improved.

### SUMMARY OF THE INVENTION

The purpose of the present invention is to effectively reduce the time of investigation, improve the efficiency of staff, and improve the safety of train operation. To this end, a method and system for investigating track risks based on big data analysis are provided.

In order to achieve the above invention objectives, the embodiment of the present invention provides the following technical solutions.

A method for identifying track risks based on big data analysis comprises the following steps.

Determine the track to be inspected and its track image data, and obtain the location information of each station on the track to be inspected; based on the location information of each station, segment the track to be inspected and obtain the segmented track.

Input the track image data corresponding to the segmented tracks into the track detection model, and output the detection results corresponding to the segmented tracks.

The track detection model includes a YOLO model and an SVM classifier connected in series.

Based on the detection results, obtain the environmental data of the segmented track, input it into the track damage prediction model, and output the corresponding damage prediction results.

The track damage prediction model adopts an RF model.

Based on the detection results, obtain the path signal corresponding to the segmented track, input it into the track fault diagnosis model, and output the corresponding fault diagnosis result.

The track fault diagnosis model adopts a BP neural network model.

Based on the detection results, damage prediction results, and fault diagnosis results, plan the path of the track to be inspected and obtain the corresponding inspection path.

According to the inspection path, dispatch investigation personnel to investigate the track to be inspected.

The training process of the track detection model includes:

Step S11, Obtain training track image data and its first label. The first label includes damage, deformation, and normal.

Step S12, Select the training track image data corresponding to any segmented track and input it into the YOLO model along with the corresponding first label to obtain the initial training detection result.

Step S13, Input the initial training detection results into the SVM classifier to obtain the training detection results; wherein the training detection results are divided into to be inspected and normal. The pending investigation includes training deformation detection results and training damage detection results. The normal result refers to the normal training and detection results.

Step S14, Based on the training detection results, calculate the corresponding loss function.

Step S15, Repeat the steps S12 to S14 until the loss function corresponding to all segmented tracks is obtained.

Step S16, Calculate the final loss function based on all the aforementioned loss functions. Based on the final loss function, adjust the weight parameters of the track detection model to complete the training of the track detection model.

The training process of the track damage prediction model includes:

Step S21, obtain the historical environmental parameters and their second labels corresponding to the training deformation detection results. The historical environmental parameters include historical temperature data and historical humidity data; The second label is damage and normal.

Step S22, Input the training deformation detection results, historical environmental parameters, and their second labels into the RF model, and output the corresponding damage prediction results.

Step S23, Calculate the mean square error loss function based on the damage prediction results.

Step S24, Based on the mean square error loss function, adjust the parameters of the track damage prediction model to complete the training of the track damage prediction model.

The training process of the track fault diagnosis model includes:

Step S31, Obtain training path signal data and its third label; wherein the training path signal data is divided into training path signals corresponding to the training deformation detection results, training path signals corresponding to the training damage detection results, and training path signals corresponding to the training normal detection results. The third tag includes line faults and line non faults corresponding to the track, namely signal fault points and signal non fault points;

Step S32, Input the training path signal data and its third label into the BP neural network model, and output the corresponding training fault diagnosis result.

Step S33, Based on the training fault diagnosis results, calculate the corresponding cross entropy loss function.

Step S34, Based on the cross entropy loss function, adjust the weight parameters of the BP neural network model using back propagation algorithm and gradient descent algorithm to complete the training of the track fault diagnosis model. The training fault diagnosis results include training signal fault points and training signal non fault points.

Based on the detection results, risk probability data, and diagnosis results, path planning is performed on the track to be inspected to obtain the corresponding inspection path, which includes:

Set a damage threshold and divide the damage prediction results into high-risk damage prediction results and low-risk damage prediction results based on the damage threshold. Take the track corresponding to the detection result of ‘to be inspected’, the damage prediction result of ‘high-risk damage prediction result’, and the diagnosis result of ‘signal fault point’ as the first priority node. The second priority node is the track corresponding to the detection result being to be inspected, the damage prediction result being a high-risk damage prediction result, and the diagnosis result being a non signal fault point, as well as the detection result being to be inspected, the damage prediction result being a low-risk damage prediction result, and the diagnosis result being a signal fault point; Take the track corresponding to the detection result of ‘to be inspected’, the damage prediction result of ‘low-risk damage prediction result’, and the diagnosis result of ‘non signal fault point’ as the third priority node; Obtain the location information of the first to third priority nodes.

Calculate the distance between the first priority node and the site; and based on the distance, determine the station with the shortest distance between each first priority node, and obtain the location relationship map between the first priority node and the station.

Based on the location relationship graph, the second priority node, the third priority node, and the location information of each station, the greedy ant colony algorithm is used to plan the path of the track to be inspected and obtain the inspection path.

Furthermore, based on the location information of each station, the track to be inspected is segmented and the segmented track is obtained, including: dividing the track between two adjacent stations on the track to be inspected into an independent segment based on the location information of the station, and obtaining the segmented track.

Furthermore, the process of obtaining the orbit image data is as follows:

By using drones to take side and overhead shots of the track to be inspected, two corresponding side video data and one overhead video data are obtained; Extract the side video data and the overhead video data according to the preset frame rate, and obtain the corresponding side image data and overhead image data.

Perform data cleaning, image enhancement, size conversion, and normalization on each of the side image data and the overhead image data to obtain corresponding processed side image data and overhead image data; Splicing the processed overhead image data with the corresponding two processed side image data to obtain the track image data.

Furthermore, the greedy ant colony algorithm for path planning includes:

Initialize the path and use M sites as starting nodes, with the first priority node as a neighbor node.

Based on the location relationship graph, allocate N investigation personnel from each site to the nearest neighbor node.

Update the path and add the selected nodes to the path; Update the location information of all investigators.

Using the second priority node as a neighbor node, based on the updated location information of the investigators, the location information of the second priority node, and the path selection principle, the ant colony algorithm is used to select the next node; Update the path and add the selected nodes to the path; Update the location information of all investigators.

Repeat the above process until all nodes are selected, and output the troubleshooting path.

The principle of path selection is to select the node with the shortest distance; If multiple investigators have the same distance to the same node, the investigator with fewer nodes will select that node, while the investigator with more nodes will select the node with the second shortest distance.

A track risk assessment system based on big data analysis, comprising an information collection and processing module, a track detection module, a track damage prediction model module, a track fault diagnosis model module, and a path planning module.

The information collection and processing module is used to obtain the track to be inspected and its track image data, environmental data, path signals, and to obtain the location information of each station on the track to be inspected; And based on the location information of each station, segment the track to be inspected and obtain the segmented track;

Track detection module, used to detect the track image data corresponding to the segmented tracks using YOLO model and SVM classifier respectively, and obtain the detection results.

The track damage prediction model module is used to use an RF model to predict damage to the detection results and environmental data, and obtain the damage prediction results.

The track fault diagnosis model module is used to use a BP neural network model to judge the path signal corresponding to the segmented track based on the detection results and damage prediction results, and obtain the fault diagnosis result.

The path planning module is used to use the greedy ant colony algorithm to plan the path of the track to be inspected based on the detection results, damage prediction results, and fault diagnosis results.

The present invention has the following beneficial effects:

The present invention uses the YOLO model and SVM classifier to detect the track and extract the multi-scale features of the track image, which can quickly and effectively detect the deformation and damage locations in the track. Based on the detection results, the RF model and BP neural network are used to further analyze the fault points of the track, and the output of each model is combined to accurately determine the fault points in the track, thereby reducing the misjudgment and omission of fault points, and providing effective support for subsequent troubleshooting path planning. According to the fault point, the greedy algorithm and the ant algorithm are combined to formulate the troubleshooting path, which can effectively reduce the troubleshooting time, improve the efficiency of the staff, improve the safety of train operation, and assist in train operation management.

### BRIEF DESCRIPTION OF THE DRAWINGS

In order to more clearly illustrate the technical solutions of the embodiments of the present invention, the following briefly introduces the drawings required for use in the embodiments. It should be understood that the following drawings only illustrate certain embodiments of the present invention and should not be regarded as limiting the scope. For those skilled in the art, other relevant drawings can be obtained based on these drawings without creative work.

FIG. 1 is a flowchart of the invention in an embodiment of the present invention.

FIG. 2 is a schematic diagram of the troubleshooting path in an embodiment of the present invention.

FIG. 3 is a system module diagram in an embodiment of the present invention.

### DETAILED DESCRIPTION OF THE INVENTION

The technical solutions in the embodiments of the present invention will be clearly and completely described below in conjunction with the drawings in the embodiments of the present invention. Obviously, the described embodiments are only a part of the embodiments of the present invention, not all of the embodiments. The components of the embodiments of the present invention generally described and shown in the drawings herein can be arranged and designed in various different configurations. Therefore, the following detailed description of the embodiments of the present invention provided in the drawings is not intended to limit the scope of the claimed invention, but merely represents selected embodiments of the present invention. Based on the embodiments of the present invention, all other embodiments obtained by those skilled in the art without making creative work are within the scope of protection of the present invention.

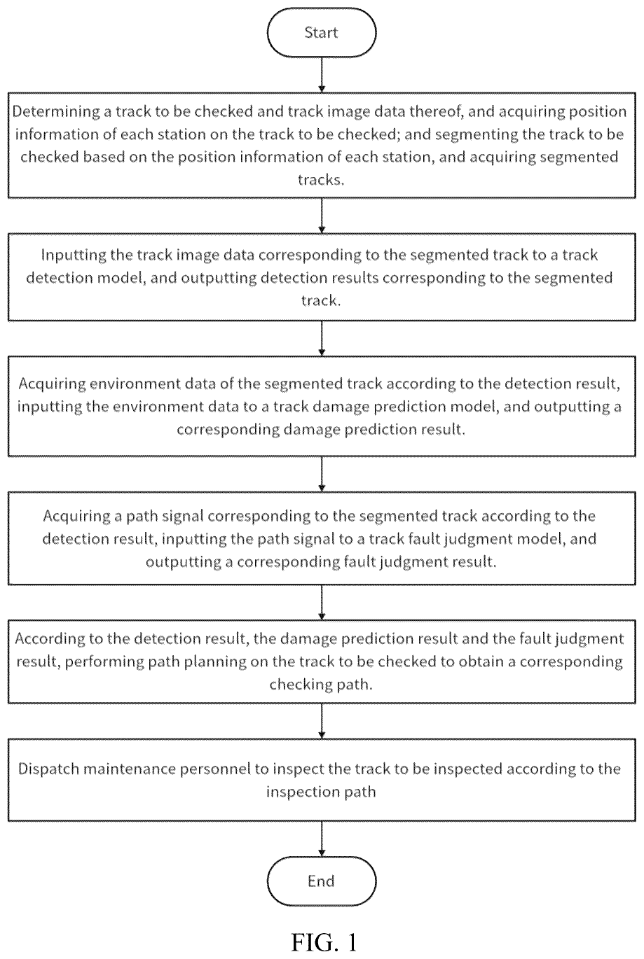

Refer to FIG. 1, a method for identifying track risks based on big data analysis is shown according to one embodiment of the invention, which includes:

Determine the track to be inspected and its track image data, and obtain the location information of each station on the track to be inspected; Based on the location information of each station, segment the track to be inspected and obtain the segmented track.

Based on the location information of each station, segment the track to be inspected and obtain the segmented track, including: dividing the track between two adjacent stations on the track to be inspected into an independent segment based on the location information of the station, and obtaining the segmented track. Segmenting the inspection track can reduce the operational burden and time of subsequent track detection models, thereby improving the calculation speed of the present invention.

The process of obtaining the orbit image data is as follows:

By using drones to take side and overhead shots of the track to be inspected, two corresponding side video data and one overhead video data are obtained; Extract the side video data and the overhead video data according to the preset frame rate, and obtain the corresponding side image data and overhead image data.

Perform data cleaning, image enhancement, size conversion, and normalization on each of the side image data and the overhead image data to obtain corresponding processed side image data and overhead image data; splicing the processed overhead image data with the corresponding two processed side image data to obtain the track image data.

Input the track image data corresponding to the segmented tracks into the track detection model, and output the detection results corresponding to the segmented tracks.

The track detection model includes a YOLO model and an SVM classifier connected in series. The YOLO model adopts the YOLOv4 neural network model for detecting deformation, cracks, and other damages in track images. The SVM classifier is used to classify the initial detection results output by YOLOv4 into deformation detection results and damage detection results.

The training process of the track detection model includes:

Step S11, Obtain training track image data and its first label; The first label includes damage, deformation, and normal.

Step S12, Select the training track image data corresponding to any segmented track and input it into the YOLO model along with the corresponding first label to obtain the initial training detection result.

Step S13, Input the initial training detection results into the SVM classifier to obtain the training detection results; wherein the training detection results are divided into to be inspected and normal; The pending investigation includes training deformation detection results and training damage detection results; The normal result refers to the normal training and detection results; The training damage detection result is cracks or fissures.

Step S14, Based on the training detection results, calculate the corresponding loss function.

Step S15, Repeat the steps S12 to S14 until the loss function corresponding to all segmented tracks is obtained.

Step S16, Calculate the final loss function based on all the aforementioned loss functions; Based on the final loss function, adjust the weight parameters of the track detection model to complete the training of the track detection model.

The calculation formula for the final loss function Loss is:

$$Loss = \frac{1}{n} {{\sum }_{i}}^{n} {loss}_{i} ,$$

$${loss}_{i} = λ ( 1 - {GIOU}_{i} ) - ( 1 - λ ) [ {y}_{i} log ( {σ ( z )}_{i} ) + ( 1 - {y}_{i} log ( 1 - {σ ( z )}_{i} ) ] ,$$

wherein n represents the total number of segmented tracks, Σ(·) representing a summation function, max(·) representing the maximum value function, λ representing weight coefficients, GIOUᵢ represents the generalized intersection ratio between the predicted box and the true box of the i-th YOLO model, represents the output of the sigmoid function in the i-th SVM classifier, yᵢ represents the label corresponding to the i-th initial detection result.

Using the YOLO model to extract image features of the track to be inspected, outputting initial detection results, and then using an SVM classifier to classify the initial detection results, this multi-stage detection can improve the accuracy of identifying damage and deformation; The YOLO model captures multi-scale features of orbit images, and the SVM classifier further subdivides them into deformation and damage based on the multi-scale features of orbit images, increasing the classification granularity and helping to improve the workload of staff, reduce the complexity of subsequent path planning, and assist path planning in providing more accurate troubleshooting paths.

Based on the detection results, obtain the environmental data of the segmented track, input it into the track damage prediction model, and output the corresponding damage prediction results.

The track damage prediction model adopts an RF model for predicting damage based on the deformation detection results and corresponding environmental parameters output by the SVM classifier; By combining temperature and humidity, utilizing the powerful feature processing capability of RF models and their ability to handle nonlinear relationships, the relationship between temperature, humidity, and deformation results and the occurrence of cracks in the track can be well captured, thereby accurately predicting the probability of track damage. The training process of the track damage prediction model includes:

Step S21, Obtain the historical environmental parameters and their second labels corresponding to the training deformation detection results; The historical environmental parameters include historical temperature data and historical humidity data; The second label is damage and normal.

Step S22, Input the training deformation detection results, historical environmental parameters, and their second labels into the RF model, and output the corresponding damage prediction results.

Step S23, Calculate the mean square error loss function based on the damage prediction results.

Step S24, Based on the mean square error loss function, adjust the parameters of the track damage prediction model to complete the training of the track damage prediction model.

Using RF models to capture the relationship between temperature, humidity, deformation detection results, and track damage, and predicting track damage based on this relationship, combined with environmental parameters and deformation results, providing strong support for track maintenance and damage prevention.

Based on the detection results, obtain the path signal corresponding to the segmented track, input it into the track fault diagnosis model, and output the corresponding fault diagnosis result.

The track fault diagnosis model adopts a BP neural network model, which is used for fault detection of the track to be inspected in the path signal, to detect whether there is a red light band phenomenon (red light band fault) in the track to be inspected, that is, the signal fault point.

The training process of the track fault diagnosis model includes:

S31, Obtain training path signal data and its third label; wherein the training path signal data is divided into training path signals corresponding to the training deformation detection results, training path signals corresponding to the training damage detection results, and training path signals corresponding to the training normal detection results; The third tag includes line faults and line non faults corresponding to the track, namely signal fault points and signal non fault points.

Step S32, Input the training path signal data and its third label into the BP neural network model, and output the corresponding training fault diagnosis result.

Step S33, Based on the training fault diagnosis results, calculate the corresponding cross entropy loss function.

Step S34, Based on the cross entropy loss function, adjust the weight parameters of the BP neural network model using back propagation algorithm and gradient descent algorithm to complete the training of the track fault diagnosis model; The training fault diagnosis results include training signal fault points and training signal non fault points.

By utilizing the powerful nonlinear mapping ability, self-learning ability, generalization ability, and other advantages of the BP neural network model, high-precision diagnosis of track red light strip faults can be achieved, ensuring the normal operation of the track, assisting the platform in accurately obtaining train information on the track, and maintaining communication between the platform and the train.

Based on the detection results, damage prediction results, and fault diagnosis results, plan the path of the track to be inspected and obtain the corresponding inspection path.

Based on the detection results, risk probability data, and diagnosis results, plan the path of the track to be inspected and obtain the corresponding inspection path, including:

Set a damage threshold and divide the damage prediction results into high-risk damage prediction results and low-risk damage prediction results based on the damage threshold; Take the track corresponding to the detection result of ‘to be inspected’, the damage prediction result of ‘high-risk damage prediction result’, and the diagnosis result of ‘signal fault point’ as the first priority node; The second priority node is the track corresponding to the detection result being to be inspected, the damage prediction result being a high-risk damage prediction result, and the diagnosis result being a non signal fault point, as well as the detection result being to be inspected, the damage prediction result being a low-risk damage prediction result, and the diagnosis result being a signal fault point; Take the track corresponding to the detection result of ‘to be inspected’, the damage prediction result of ‘low-risk damage prediction result’, and the diagnosis result of ‘non signal fault point’ as the third priority node; Obtain the location information of the first to third priority nodes; Each location information is DEM data.

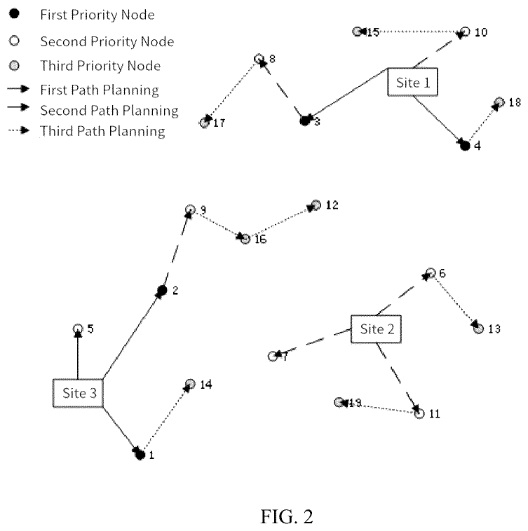

In one embodiment, as shown in FIG. 2, the track of a certain area is determined as the track to be inspected, and the three stations on the track to be inspected and their corresponding location information are obtained; obtain corresponding detection results, risk probability data, and diagnosis results through various models. Take the track corresponding to the detection and diagnosis results as the node; count the number of nodes as 19 and randomly label them; based on the detection results, risk probability data, and diagnosis results, nodes 1 to 4 are designated as the first priority nodes, nodes 5 to 11 are designated as the second priority nodes, and nodes 12 to 19 are designated as the third priority nodes.

Calculate the distance between the first priority node and the site; And based on the distance, determine the station with the shortest distance between each first priority node, and obtain the location relationship map between the first priority node and the station.

Based on the location relationship graph, the second priority node, the third priority node, and the location information of each station, the greedy ant colony algorithm is used to plan the path of the track to be inspected and obtain the inspection path.

Greedy ant colony algorithm for path planning includes:

Initialize the path and use M sites as starting nodes, with the first priority node as a neighbor node.

Based on the location relationship graph, allocate N investigation personnel from each site to the nearest neighbor node.

Update the path and add the selected nodes to the path; Update the location information of all investigators.

Using the second priority node as a neighbor node, based on the updated location information of the investigators, the location information of the second priority node, and the path selection principle, the ant colony algorithm is used to select the next node; Update the path and add the selected nodes to the path. Update the location information of all investigators;

When using ant colony algorithm to select the next node, set the initial pheromone concentration and parameters of the ant colony, including pheromone importance factor, heuristic pheromone importance factor, and pheromone volatilization rate; Using the current location information of the inspector as the initial point for ants, the inspector may be the ant. At this point, the location information of the inspector may be entirely the location of the first priority node, partially the location of the first priority node, and partially the location of the site; Randomly initialize the starting order of ants and calculate the probability of each ant selecting the second priority node based on ant colony parameters and initial pheromone concentration; Based on probability, select the second priority node as the next node for ants until all second priority nodes are selected.

Repeat the above process until all nodes are selected, and output the troubleshooting path.

The principle of path selection is to select the node with the shortest distance; If multiple investigators have the same distance to the same node, the investigator with fewer nodes will select that node, while the investigator with more nodes will select the node with the second shortest distance.

Each site has 3 inspectors, for a total of 9 inspectors; Calculate the location relationship diagram between the first priority node and the sites, with 3 sites as starting points and the first priority node as a neighbor node. Using the greedy algorithm to select neighboring nodes, if nodes 1 and 2 are closer to site 3, and nodes 3 and 4 are closer to site 1, then both site 1 and site 3 will send two inspectors to go to nodes 3, 4, 1, and 2 respectively. The inspectors for site 2 and the remaining inspectors for site 1 and site 3 will remain stationary. Update the location information of all investigators. Calculate the distance between all investigators and the second priority node, and use the location information of all investigators as the initial node for ants; Select the next node based on the size of the pheromone and the principle of path selection, that is, node 5 is closer to site 3, and node 9 is closer to node 2. Therefore, dispatch the remaining investigation personnel from site 3 to node 5, and dispatch the investigation personnel from node 2 to node 9; Node 8 is closer to Node 3, and Node 10 is closer to Site 1. Therefore, the investigation personnel of Node 3 will be dispatched to Node 8, and the remaining investigation personnel of Site 1 will be dispatched to Node 10; Nodes 6, 7, and 11 are closer to Site 2, so the three investigators from Site 2 were dispatched to Nodes 6, 7, and 11 respectively. Update the location information of all investigators. Calculate the distance between all investigators and the third priority node, and use the location information of all investigators as the initial node for ants; Select the next node based on the size of the pheromone and the principle of path selection, that is, if node 13 is closest to node 6, dispatch the investigation personnel of node 6 to node 13; Node 14 is the closest to Node 1, thus dispatching the investigation personnel from Node 1 to Node 14; Node 16 is the closest to Node 9, thus dispatching the investigation personnel from Node 9 to Node 16; Node 19 is the closest to Node 11, thus dispatching the investigation personnel from Node 11 to Node 19; Node 15 is the closest to Node 10, thus dispatching the investigation personnel from Node 10 to Node 15; Node 4 is the closest to Node 18, thus dispatching the investigation personnel from Node 4 to Node 18; At this point, the remaining node 12 may not be selected, so update the location information of all investigation personnel again, repeat the above process, determine that node 16 is closest to node 12, and dispatch the investigation personnel of node 16 to node 12.

By combining the advantages of greedy algorithm and ant colony algorithm, the problem of greedy algorithm easily getting stuck in local optima during path planning can be improved. This enables more accurate selection of nodes with the shortest time or distance, enhancing the rationality of path investigation and the efficiency of staff; improves the search efficiency for path planning; prioritizing nodes can reduce computation time.

According to the inspection path, dispatch investigation personnel to investigate the track to be inspected. Based on the detection results, risk probability data, and diagnosis results, corresponding investigation personnel can be assigned and carry relevant tools to reduce the burden on the investigation personnel; If the investigators discover other problems during the investigation on the corresponding track, they can promptly provide feedback to the cloud and further develop response plans.

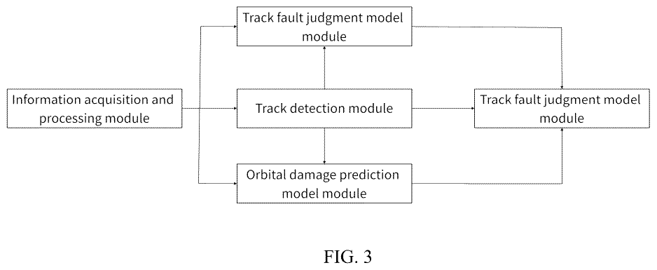

As shown in FIG. 3, a track risk assessment system based on big data analysis includes an information collection and processing module, a track detection module, a track damage prediction model module, a track fault diagnosis model module, and a path planning module; Among them:

The information collection and processing module is used to obtain the track to be inspected and its track image data, environmental data, path signals, and to obtain the location information of each station on the track to be inspected; and based on the location information of each station, segment the track to be inspected and obtain the segmented track.

Track detection module, used to detect the track image data corresponding to the segmented tracks using YOLO model and SVM classifier respectively, and obtain the detection results.

The track damage prediction model module is used to use an RF model to predict damage to the detection results and environmental data, and obtain the damage prediction results.

The track fault diagnosis model module is used to use a BP neural network model to judge the path signal corresponding to the segmented track based on the detection results and damage prediction results, and obtain the fault diagnosis result.

The path planning module is used to use the greedy ant colony algorithm to plan the path of the track to be inspected based on the detection results, damage prediction results, and fault diagnosis results, and obtain the inspection path.

In the specific implementation process, the damage detection results of the track to be inspected are obtained through the track detection model, and the crack size or area in the damage detection results is calculated; set a crack threshold and extract damage detection results with crack size or area greater than the crack threshold. When formulating the inspection path, the damage detection results with crack size or area greater than the crack threshold can be used as reference factors to develop the first to third priority nodes. Considering the magnitude of damage to the track, the inspection path can be optimized by assigning inspection personnel to locations that require more inspection, reducing the probability of errors and improving the accuracy of damage detection; Provide more targeted investigation arrangements, reduce unnecessary inspections, and improve work efficiency; Establishing a new priority sequence and promptly repairing larger cracks can help improve the service life of the track and reduce potential accident costs.

The present invention utilizes the YOLO model and SVM classifier to detect tracks, extract multi-scale features of track images, and can quickly and effectively detect deformation and damage positions in the tracks. Based on the detection results, RF model and BP neural network are used to further analyze the fault points of the track, and the output of each model is combined to accurately determine the fault points in the track, reducing the situation of misjudgment and omission of fault points and providing effective support for subsequent troubleshooting path planning. Based on the fault point, combining greedy algorithm and ant algorithm to develop a troubleshooting path can effectively reduce the troubleshooting time, improve the efficiency of staff, enhance the safety of train operation, and assist in train operation management.

The above is only a specific embodiment of the present invention, but the scope of protection of the present invention is not limited to this. Any skilled person familiar with the technical field can easily think of changes or substitutions within the technical scope disclosed in the present invention, which should be included in the scope of protection of the present invention. Therefore, the scope of protection of the present invention should be based on the scope of protection of the claims.

What is claimed is:

1. A method for identifying track risks based on big data analysis, comprising:
determining the track to be inspected and its track image data, and obtaining the location information of each station on the track to be inspected; based on the location information of each station, segmenting the track to be inspected and obtaining the segmented track;
inputting the track image data corresponding to the segmented tracks into a track detection model, and output the detection results corresponding to the segmented tracks; wherein the track detection model includes a YOLO model and an SVM classifier connected in series;
based on the detection results, obtaining environmental data of the segmented track, inputting it into a track damage prediction model, and outputting the corresponding damage prediction results; wherein the track damage prediction model includes an RF model;
based on the detection results, obtaining the path signal corresponding to the segmented track, inputting it into the track fault diagnosis model, and outputting the corresponding fault diagnosis result; wherein the track fault diagnosis model includes a BP neural network model;
based on the detection results, the damage prediction results, and the fault diagnosis results, planning the path of the track to be inspected and obtaining the corresponding inspection path;
based on the inspection path, dispatching investigation personnel to investigate the track to be inspected;
wherein the training process of the track detection model includes:
step S11, obtaining training orbit image data and its first label; wherein the first label includes damage, deformation, and normal;
step S12, selecting the training track image data corresponding to any segmented track and inputting it into the YOLO model along with the corresponding first label to obtain the initial training detection result;
step S13, inputting the initial training detection results into the SVM classifier to obtain the training detection results; wherein the training detection results are divided into to be inspected and normal; the pending investigation includes training deformation detection results and training damage detection results; the normal result refers to the normal training and detection results;
step S14, based on the training detection results, calculating the corresponding loss function;
step S15, repeating the steps S12 to S14 until the loss function corresponding to all segmented tracks is obtained;
step S16, calculating the final loss function based on all the aforementioned loss functions; based on the final loss function, adjusting the weight parameters of the track detection model to complete the training of the track detection model;
wherein the training process of the track damage prediction model includes:
step S21, obtaining the historical environmental parameters and their second labels corresponding to the training deformation detection results; wherein the historical environmental parameters include historical temperature data and historical humidity data; and the second label is damage and normal;
step S22, inputting the training deformation detection results, historical environmental parameters, and their second labels into the RF model, and outputting the corresponding damage prediction results;
step S23, calculate the mean square error loss function based on the damage prediction results;
step S24, based on the mean square error loss function, adjusting the parameters of the track damage prediction model to complete the training of the track damage prediction model;
wherein the training process of the track fault diagnosis model includes:
step S31, obtaining training path signal data and its third label; wherein the training path signal data is divided into training path signals corresponding to the training deformation detection results, training path signals corresponding to the training damage detection results, and training path signals corresponding to the training normal detection results; the third tag includes line faults and line non faults corresponding to the track, namely signal fault points and signal non fault points;
step S32, inputting the training path signal data and its third label into the BP neural network model, and outputting the corresponding training fault diagnosis result;
step S33, based on the training fault diagnosis results, calculating the corresponding cross entropy loss function;
step S34, based on the cross entropy loss function, adjusting the weight parameters of the BP neural network model using back propagation algorithm and gradient descent algorithm to complete the training of the track fault diagnosis model; wherein the training fault diagnosis results include training signal fault points and training signal non fault points;
based on the detection results, risk probability data, and diagnosis results, performing path planning on the track to be inspected to obtain the corresponding inspection path, which includes:
setting a damage threshold and divide the damage prediction results into high-risk damage prediction results and low-risk damage prediction results based on the damage threshold; taking the track corresponding to the detection result of ‘to be inspected’, the damage prediction result of ‘high-risk damage prediction result’, and the diagnosis result of ‘signal fault point’ as the first priority node; wherein the second priority node is the track corresponding to the detection result being to be inspected, the damage prediction result being a high-risk damage prediction result, and the diagnosis result being a non signal fault point, as well as the detection result being to be inspected, the damage prediction result being a low-risk damage prediction result, and the diagnosis result being a signal fault point; taking the track corresponding to the detection result of ‘to be inspected’, the damage prediction result of ‘low-risk damage prediction result’, and the diagnosis result of ‘non signal fault point’ as the third priority node; obtaining the location information of the first to third priority nodes;
calculating the distance between the first priority node and the site; and based on the distance, determining the station with the shortest distance between each first priority node, and obtaining the location relationship map between the first priority node and the station; and
based on the location relationship graph, the second priority node, the third priority node, and the location information of each station, using the greedy ant colony algorithm to plan the path of the track to be inspected and obtain the inspection path.

2. The method of claim 1, wherein the track to be inspected is segmented based on the location information of each station, and the segmented track is obtained, comprising: dividing the track between two adjacent stations on the track to be inspected into an independent segment based on the location information of the station, and obtaining the segmented track.

3. The method of claim 1, wherein the process of obtaining the track image data is as follows:
by using drones to take side and overhead shots of the track to be inspected, obtaining two corresponding side video data and one overhead video data; extracting the side video data and the overhead video data according to the preset frame rate, and obtaining the corresponding side image data and overhead image data; and
perform data cleaning, image enhancement, size conversion, and normalization on each of the side image data and the overhead image data to obtain corresponding processed side image data and overhead image data; splicing the processed overhead image data with the corresponding two processed side image data to obtain the track image data.

4. The method of claim 1, wherein the greedy ant colony algorithm for path planning comprises:
initializing the path and use M sites as starting nodes, with the first priority node as a neighbor node;
based on the location relationship graph, allocating N investigation personnel from each site to the nearest neighbor node;
updating the path and add the selected nodes to the path; updating the location information of all investigators;
using the second priority node as a neighbor node, based on the updated location information of the investigators, the location information of the second priority node, and the path selection principle, using the ant colony algorithm to select the next node; updating the path and adding the selected nodes to the path; updating the location information of all investigators; and
repeat the above process until all nodes are selected, and output the troubleshooting path;
wherein the principle of path selection is to select the node with the shortest distance; when multiple investigators have the same distance to the same node, the investigator with fewer nodes selects that node, while the investigator with more nodes selects the node with the second shortest distance.

5. A system for identifying track risks based on big data analysis, used to implement the method of claim 1, comprising:
an information acquisition and processing module, a track detection module, a track damage prediction model module, a track fault diagnosis model module, and a path planning module; wherein:
the information collection and processing module is used to obtain the track to be inspected and its track image data, environmental data, path signals, and to obtain the location information of each station on the track to be inspected; and based on the location information of each station, segment the track to be inspected and obtain the segmented track;
the track detection module is used to detect the track image data corresponding to the segmented tracks using YOLO model and SVM classifier respectively, and obtain the detection results;
the track damage prediction model module is used to use an RF model to predict damage to the detection results and environmental data, and obtain the damage prediction results;
the track fault diagnosis model module is used to use a BP neural network model to judge the path signal corresponding to the segmented track based on the detection results and damage prediction results, and obtain the fault diagnosis result; and
the path planning module is used to use the greedy ant colony algorithm to plan the path of the track to be inspected based on the detection results, damage prediction results, and fault diagnosis results, and obtain the inspection path.
